(19) United States
(12) Patent Application Publication
(10) Pub. No.: US 2005/0127910 A1
(43) Pub. Date: Jun. 16, 2005

(54) Data-processing to form a compound object data set from a plurality of basis datasets

(76) Inventors: Frederik Visser, Eindhoven (NL); Romhild Martijn Hoogeveen, Eindhoven (NL); Richard Philipsen, Eindhoven (NL); Arianne Margarethe Corinne Van Muiswinkel, Eindhoven (NL)

Correspondence Address: Thomas M Lundin;Philips Intellectual Property & Standards, 595 Miner Road, Cleveland, OH, 44143, US

(21) Appl. No.: 10/509,933

(22) PCT Filed: Mar. 20, 2003
(86) PCT No.: PCT/IB03/01150

(30) Foreign Application Priority Data
Apr. 8, 2002 (EP) 02076397.5

(51) Int. Cl. G01V 3/00

(52) U.S. Cl. 324/307

(57) ABSTRACT

A compound object data set is formed from a plurality of basis datasets. The basis datasets assigning datavalues to spatial positions in an at least throe-dimensional space. The basis datasets are associated with mutually overlapping regions. Compound datavalues for spatial positions in the overlapping regions are computed, perferably by weighted interpolation from datavalues of respective basis datasets.

The invention pertains to a method of data-processing to form a compound object data set from a plurality of basis datasets. Such a method is known from the U.S. Pat. No. 6,037,771.

The known method involves a compound object dataset in the form of a three-dimensional NMR data set that is acquired from a series of thin slab acquisitions. These thin slab acquisitions form the basis datasets. Further, the thin slab acquisitions involve acquisitions of magnetic resonance signals from a thin slab through an object to be examined, such as a patient to be examined. According to the known method, the thin slab acquisitions involve selective excitations of spins in a thin slab that slides in one spatial direction as magnetic resonance signals are acquired for the other two spatial directions. Accordingly, phase encoding sampling is interleaved for several of the thin slabs. Although the known method successfully avoids boundary artefacts in the reconstructed image, in practice signal acquisition appears very time-consuming. Moreover, the known method does not allow reconstruction of magnetic resonance images until all signal acquisition for the entire compound object dataset has been completed.

An object of the invention is to provide a method of data-processing of a plurality of basis datasets, in particular acquired by way of magnetic resonance imaging, in which boundary artefacts are better avoided than in the conventional method.

This object is achieved by a method of data-processing according to the invention comprising the step of

deriving compound datavalues for spatial positions in the overlapping regions from datavalues of respective basis datasets.

The method according to the invention is applied to multi-dimensional basis datasets. Such a multi-dimensional basis data set assigns datavalues to positions in a three-dimensional or higher-dimensional space. For example the tee-dimensional space is a three-dimensional geometric space, or a space spanned by a two-dimensional geometric space and the time-axis or a space spanned by a three-dimensional geometric space and the time-axis. Such multi-dimensional basis datasets are for example acquired in magnetic resonance imaging in that spatially overlapping volume slabs are imaged which may be dynamically repeated at successive instants in time.

In the compound object dataset, compound datavalues pertaining to positions in the mutually overlapping regions combine information from datavalues for positions in the overlapping regions of several basis datasets. Because for positions in the overlapping regions information from several basis datasets are employed, boundary artefacts in the compound object datasets are avoided. Further, the method of the invention allows to build-up the compound object dataset as more basis datasets become available, for example as the basis datasets are acquired by magnetic resonance imaging methods. Notably, transitions in the rendition of the compound object dataset that show up as undesired ‘venetian blinds’ are effectively avoided. Hence, the diagnostic quality of the renditions of the compound object dataset is improved as small details with low contrast resolution are rendered well visible.

These and other aspects of the invention will be further elaborated with reference to the embodiments defined in the dependent claims.

Preferably, the compound datavalues for the compound object dataset, at least in as far as they pertain to the mutually overlapping regions, are calculated by way of interpolation between datavalues of separate basis datasets. In this way a simple calculation which requires very little computational effort yields an appropriate combination of information from several basis datasets in the compound datavalues of the compound object dataset. Preferably weighted interpolation is applied which involves addition of for example weighted datavalues of basis datasets for adjacent spatial regions. Weighted interpolation provides more flexibility concerning the degree of influence of datavalues from respective basis datasets to the compound object dataset.

Preferably, these weights are larger for datavalues for spatial positions further away from the edge of the spatial region associated with the basis dataset at issue. Hence, datavalues from the centre regions of the basis datasets have a stronger influence on the compound datavalues than datavalues from the peripheral regions of the basis datasets. Notably, when the basis datasets are acquired by magnetic resonance methods, it appears that datavalues in the centre region of the basis datasets are far less corrupted than corruptions of the datavalues that may occur near the edges of the spatial regions of the basis datasets. Notably, particularly less corrupted magnetic resonance signals occur from the centre region when the magnetic resonance signal acquisition involves for example an inflow angiography technique. In inflow angiography a slab is magnetically saturated to a high degree, e.g. by repeatedly applying a selective RF excitation. Contrast then arises due to magnetic resonance signals from less saturated, or unsaturated spins that move into the saturated slab. This technique is particularly useful for imaging bloodvessels. As ‘fresh’ blood flows into the saturated slab, the bloodvessels contain a high degree of less saturated spins and the bloodvessels eventually show up with a higher contrast in the basis datasets reconstructed from the magnetic resonance signals.

In practice the repeated spatially selective RF excitation generate complete saturation in the central region of the selected slab, but far from complete saturation occurs at the edges of the selected slab. Moreover, as the blood in the bloodvessels moves through the saturated slab, the spins in the blood experience a number of spatially selective RF-excitations so that the spins in the blood become magnetically more saturated as they move through the slab and the contrast between stationary tissue and the blood is less at the ‘downstream’ edge of the slab at issue. When the spatially adjacent slab is imaged, again the contrast decreases towards the ‘downstream’ edge. It is noted that as a next slab is imaged, the saturation of the previous slabs has ceased, so that again ‘fresh’ spins enter at the ‘upstream’ end of the slab at issue. The saturation disappears after the spatially selective RF excitations in the slab at issue cease. The time scale on which the saturation disappears is far shorter than the interval between acquisition of magnetic resonance signals from successive slabs. Consequently, in the overlapping portions of adjacent slabs concern low contrast due to somewhat saturated spins of the blood being ‘downstream’ in the previous slab and also concern high contrast due to ‘fresh’ spins being ‘upstream’ in the current slab. According to the invention, this difference between high and low contrast in the overlapping region is averaged out in the compound datavalues. As the least corrupted datavalues occur away from the edges of the spatial regions of the data sets and the weights involved in the interpolation are non-decreasing, preferably increasing the least corrupted datavalues have the larger influence on the compound datavalues. Magnetic resonance signals are preferably acquired for successive slabs that are located relative to one another ‘upstream’, that is the order of acquisition of magnetic resonance signals from slab is carried-out in a direction against the bloodstream. To some extent such an acquisition strategy reduces ‘venetian blind’ type artefacts in the compound object dataset and according to the invention the use of compound datavalues effectively reduces the brightness transitions between portions in the compound object dataset that originate from adjacent basis datasets to such an extent that the diagnostic quality of the compound object dataset is improved. The compound object dataset has a high diagnostic quality in that small details with low contrast are made well visible and brightness transitions not relating to the patient's anatomy to be examined are avoided.

Consequently, the bloodvessels appear with a high contrast in the compound object dataset that is formed from the basis datasets. The contrast of the rendition of the bloodvessels may be further enhanced by applying a maximum intensity projection (MIP) to the compound object dataset.

According to one aspect of the invention, the order of acquisition runs from the centre towards the edge of the spatial region of the basis dataset at issue. As the saturation of the magnetisation deteriorates somewhat during the acquisition of the magnetic resonance signals for individual basis datasets, the magnetic resonance signals pertaining to the centre of the spatial region of the basis datasets are less corrupted than the magnetic resonance signals for the edges. Boundary artefacts in the compound object datasets are better avoided as datavalues associated with spatial positions near the centres of respective basis datasets have a stronger influence of the compound datavalues. There are several ways to increase the influence of datavalues pertaining to the centre spatial regions associated with the basis datasets. Use of higher weights for datavalues pertaining to the centre spatial region relative to the spatial edge region in the weighted interpolation of the calculation of the compound datavalues favours the less corrupted datavalues. This is easily implemented by increasing the weights with distance from the edge to the centre of the spatial region of the basis datasets concerned. In particular such increase of the weights from the edge to the centre of the spatial region of the basis dataset at issue is applied in the overlapping neighbouring spatial regions of respective basis datasets. Particularly favourable results are obtained when the increase of the edge to the centre of the weights for the spatial region of the basis dataset at issue is more strongly as the overlap between the neighbouring spatial regions is less. Usually in the overlapping regions the risk of corruption of the data values is higher, e.g. due to less complete saturation of the stationary tissue and due to the difference between the degree of saturation of spins at the downstream end of the spatial region on one basis dataset and the degree of saturation of (mainly the same) spins at the upstream end of the spatial region of the next basis dataset. Note that these downstream and upstream end are included in the overlapping regions. The dependence of the increase of the weights on the amount of overlap thus appropriately takes into account the expected quality of the datavalues in the overlapping regions. For larger overlapping regions the compound datavalues have been more influenced by datavalues from both basis datasets involved in the overlap. For smaller overlapping regions, the compound datavalues are more biased to the datavalues of either basis datasets involved in the overlap.

During or after acquisition of a basis datasets, non-overlapping parts can be reconstructed immediately for the compound object dataset. In the overlapping regions, the compound datavalues for the compound object dataset can be computed as soon as again a next basis dataset is available. Thus, the compound object dataset can be formed as the acquisition of more basis datasets continues. Hence, the compound object dataset is completed shortly after the completion of the acquisition of the magnetic resonance signals for all basis datasets.

It is noted that the U.S. Pat. No. 6,097,833 shows that a two-dimensional compound image is made from portions of several two-dimensional sub-images. Only portions of the sub-images are used to avoid deformations in the sub-images to occur in the compound image. The method known form U.S. Pat. No. 6,097,833 is applicable to two-dimensional projection x-ray images. In particular no indication is given to extend this known method to a three-dimensional dataset.

These and other aspects of the invention will be elucidated with reference to the embodiments described hereinafter and with reference to the accompanying drawing wherein

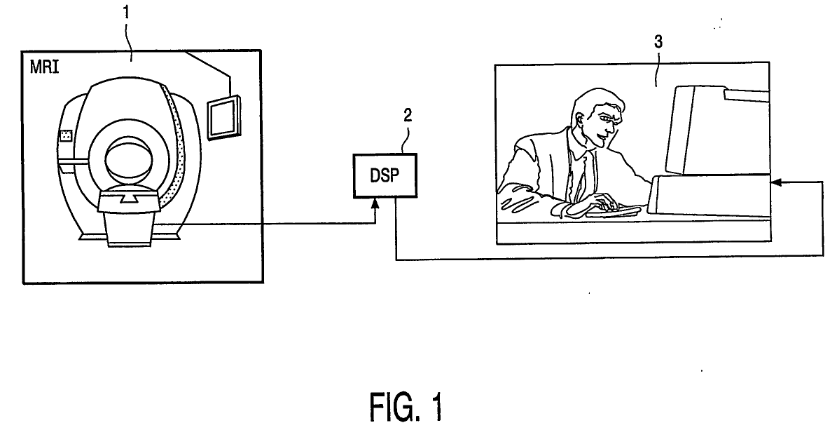

FIG. 1 shows a schematic representation of a magnetic resonance imaging system in which the method of the invention is employed.

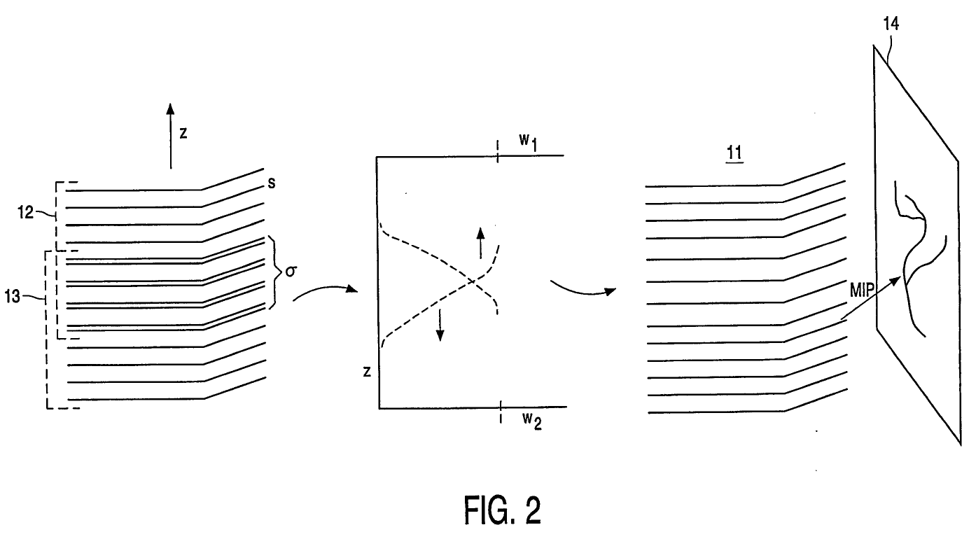

FIG. 2 shows a diagrammatic representation of the method of data processing according to the invention to form the compound object dataset from the basis datasets.

FIG. 1 shows a schematic representation of a magnetic resonance imaging system in which the method of the invention is employed. The magnetic resonance imaging system includes an imaging modality 1 (MRI) which supplies image data to the data processing system 2 (DSP). The data processing system derives the compound object data set from the image data. The compound object data set is then applied to a display system 3. A rendition of the compound object data set is displayed on the display system 3. For example a maximum intensity projection is applied to form a projection image showing a part of the patients bloodvessel system. Optionally, other image processing may be applied to these image data by the data processing unit to improve the rendition of the image data on the display system.

FIG. 2 shows a diagrammatic representation of the method of data processing according to the invention to form the compound object dataset from the basis datasets. By way of example FIG. 2 shows the formation of the compound object dataset 11 from two basis datasets 12,13. The individual basis datasets 12,13 pertain for example to three-dimensional volumes shaped as volume slabs. The magnetic resonance signals in these slabs are acquired with a three-dimensional spatial encoding imposed by temporary magnetic gradient fields, notably by read-gradients and phase-encoding gradients. Individual volume slabs include respective sets of two-dimensional (2D) datasubsets in the form of slices (s) which extend in the (x,y)-plane. Individual slices have a 2D matrix of pixels (e.g. 256×256) and respective slices are located at respective positions in the direction (z) perpendicular to the slices.

From the datavalues in the basis datasets, at least partly by way of interpolation the compound datavalues for the compound object dataset 11 are calculated. Subsequently, for example the maximum intensity projection (MIP) is applied to the compound object dataset to produce a projection dataset. The projection dataset can be supplied to the display system 3 to view the patient's vascular system.

The basis datasets 12,13 have a spatial overlap (o) in which there are four slices associated in common with both adjacent basis datasets. That is, datavalues are available from both adjacent basis datasets for the same spatial positions. This is indicated in FIG. 2 in that the slices in the overlapping region (o) are indicated in two-fold. The compound datavalues for the compound object dataset 11 are computed as follows. Datavalues from the basis datasets 12,13 outside of the overlapping region are carried over to the corresponding position in the compound object dataset 11. Thus the compound data value d_{c} is:
d_{c}(x, y, z)=dᵢ(x, y, z) for (x,y,z) outside of the overlap.

From datavalues d₁, d₂ in the overlapping regions for the respective basis dataset the weighted average computed so as to form the compound datavalue for the spatial position at issue for the compound object dataset

$${d}_{c} ( x , y , z ) = {\sum }_{i} {w}_{i} ( z ) {d}_{i} ( x , y , z )$$

for (x,y,z) within the overlap.

The index i runs over the respective basis datasets. The weights wᵢ(z) are graphically shown in the graph in FIG. 2. The weights wᵢ are maximum at the centre of the spatial region of their proper basis datasets and decay towards the periphery of the spatial region of the basis dataset at issue. Thus, the compound datavalues are biased towards the datavalues from the centre regions of the respective basis datasets.

1. A method of data-processing to form a compound object data set from a plurality of basis datasets
the basis datasets assigning datavalues to spatial positions in an at least three-dimensional space,
the basis datasets being associated with mutually overlapping regions, the method comprising the step of
deriving compound datavalues for spatial positions in the overlapping regions from datavalues of respective basis datasets.

2. A method as claimed in claim 1, wherein the compound datavalues are calculated by interpolation between datavalues of the basis datasets and for corresponding positions in the overlapping regions.

3. A method as claimed in claim 2, wherein the calculation of compound datavalues involves a weighted interpolation.

4. A method as claimed in claim 3, wherein
weights for datavalues of individual basis datasets are associated with their spatial positions in the respective spatial regions of said basis datasets and
for respective basis datasets, the weights are non-decreasing with distance to an edge of the spatial region of the basis dataset concerned.

5. A method as claimed in claim 4, wherein
the respective basis datasets have neighbouring spatial regions and
said increasing of the weights with distance to an edge of the spatial region of the basis dataset concerned is dependent on the overlap between the neighbouring spatial regions

6. A method as claimed in claim 5, wherein said increasing with distance to an edge of the spatial region of the basis dataset concerned is more strongly as there is less overlap between the adjacent spatial regions.

7. A method as claimed in claim 1, wherein individual basis datasets are reconstructed from magnetic resonance signals.

8. A method as claimed in claim 1, wherein the basis datasets include a datavalues that are encoded in three independent spatial directions of a multitude of two-dimensionally encoded datasubsets.

9. A method as claimed in claim 9, wherein
for individual basis data sets, sets of magnetic resonance signals are successively acquired for the respective positions in one spatial encoding direction or for the respective two-dimensional datasubsets and
where the order of acquisition runs from the centre towards the edge of the spatial region of the basis dataset concerned.
